(19) United States
(12) Patent Application Publication
(10) Pub. No.: US 2006/0101406 A1
(43) Pub. Date: May 11, 2006

(54) Object test bench

(75) Inventors: Gautam Goenka, Hyderabad (IN); Partho P. Das, Hyderabad (IN); Umesh Unnikrishnan, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/255,066

(22) Filed: Oct. 20, 2005

Related U.S. Application Data
(60) Provisional application No. 60/621,517, filed on Oct. 21, 2004.

(51) Int. Cl. G06F 9/44

(52) U.S. Cl. 717/124

(57) ABSTRACT

A facility for testing an object in an integrated development environment without providing source code or knowing semantics of a language is described. In various embodiments, the facility receives an instantiated object, displays the instantiated object visually, receives a command from a developer relating to the instantiated object, and provides a result corresponding to the received command. As an example, the facility invokes a method provided by the instantiated object or retrieves a value of a property of the instantiated object.

### CROSS-REFERENCE TO RELATED APPLICATIONS

This patent application claims the benefit of U.S. Provisional Patent Application No. 60/621,517, entitled “Object Test Bench,” which was filed on Oct. 21, 2004, the disclosure of which is incorporated herein in its entirety by reference.

### BACKGROUND

Software developers generally use integrated development environments (IDEs), e.g., to edit, build, and debug applications. An example of an IDE is MICROSOFT VISUAL STUDIO (VS), which is a software development tool that the assignee of the instant patent application developed and commercializes. IDEs provide a user interface that developers can use, e.g., to edit, build, and debug software components and applications. IDEs generally include developer tools, such as a source code editor, a compiler and/or interpreter, a build-automation tool, and a debugger. IDEs may also include a version control system and other tools to simplify construction of a graphical user interface (GUI). Modern IDEs such as VS also include a class browser and an object inspector to facilitate object-oriented software development.

Software developers sometimes develop portions of a computer program, such as objects, classes, or other software components (collectively, “objects”) that will be used by other software developers who are developing other portions of an application. As an example, one software developer may develop an object that another software developer integrates into an application. In such cases, the software developer who is developing the object may desire to test the object without writing an application that consumes the object. Alternatively, a student of software development may desire to learn how an object responds to various inputs.

### SUMMARY

A facility is described that provides an object test bench (“OTB”) that simplifies debugging and testing of objects within an IDE. In various embodiments, the facility provides a graphical view of objects and a GUI to interact with these objects. The facility creates the graphical view while the IDE is in a “design time” mode. Developers are able to use the facility to test objects without entering a “debug time” or “runtime” mode of the IDE and without writing any code. A developer adds an object to be tested (e.g., a class) to a tool window of the OTB, such as by selecting the object in a list of objects and invoking an “instantiate” command. In response, the OTB creates a new instance of the object and displays the instance visually in the OTB's tool window. The developer can then interact with the created object, such as by selecting a context menu associated with the object and invoking a command from the context menu. As an example, the developer can invoke a method the object provides and inspect or set the object's properties. Thus, the developer can test the object without writing code or perhaps even knowing a programming language.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example of a suitable computing environment in which aspects of the facility may be implemented.

FIG. 2 is a block diagram illustrating components associated with the facility in various embodiments.

FIG. 3 is a display diagram illustrating an object test bench tool window that the facility provides in various embodiments.

FIG. 4 is a display diagram illustrating an object appearing in an object test bench tool window in various embodiments.

FIG. 5 is a display diagram illustrating a context menu associated with the object test bench tool window in various embodiments.

FIG. 6 is a display diagram illustrating a context menu associated with an invoke method command.

FIG. 7 is a display diagram illustrating a dialog box associated with the “invoke method” command.

FIG. 8 is a display diagram illustrating an object property inspection feature of the facility.

FIG. 9 is a display diagram illustrating an object property modification feature of the facility.

FIG. 10 is a display diagram illustrating a results window that the facility employs in various embodiments to return results to the developer.

FIG. 11 is a flow diagram illustrating a test routine performed by the routine in various embodiments.

### DETAILED DESCRIPTION

A software facility for testing objects (“the facility” or “object test bench” (OTB)) is described that simplifies debugging and testing of objects within an IDE, such as VS. In various embodiments, the facility provides a graphical view of objects and a GUI to interact with these objects. The facility creates the graphical view of objects while the IDE is in a “design time” mode. When the IDE is in design time mode, the software developer can edit source code. Developers are able to use the facility to debug objects without entering a “debug time” or “runtime” mode of the IDE and without writing any code to test the object. When an IDE is operating in “debug time” or “runtime” modes, a developer generally cannot edit many aspects of source code of an application that the IDE debugs or executes. Moreover, IDEs conventionally require software they debug or execute to have a “main” function or other entry point when the IDE enters debug or runtime modes. By enabling objects to be debugged in design time mode instead of debug time or runtime, the facility enables software developers to quickly test objects without fully writing an application that consumes or otherwise employs the object. Moreover, the facility may be useful for new software developers who are not familiar with debuggers or prefer to debug with GUIs.

To test or interact with an object, a developer adds the object (e.g., a class) to the OTB, such as by selecting the object in a list of objects and invoking an “instantiate” command. In response, the OTB creates a new instance of the object and displays the instance visually in a tool window associated with the OTB. The developer can then interact with the created object, such as by selecting a context menu associated with the object and invoking a command appearing in the context menu. As an example, the developer can invoke a method the object provides. The developer can also inspect or set properties associated with the object. Thus, the developer can test the object without writing an application or perhaps even knowing a programming language.

In some embodiments, the facility is language-neutral and enables a developer to debug an object that was written using any of various programming languages, such as C, VISUAL C++, VISUAL C#, VISUAL J#, and VISUAL BASIC. A developer can use the facility to test an object that was written using any of these or other programming languages. Additionally, developers can use the facility to quickly discover functionality provided by various components, including components other software developers or vendors provide. As an example, a developer can discover an application program interface (API) that an object exposes. The facility achieves this language neutrality by employing a “Code Model” application program interface (API) of the IDE. The code model API enables components of the IDE to interact with other components without needing to provide or recognize language-specific semantics.

In some embodiments, the facility employs a .NET Framework to generate expressions that the facility employs to interact with the object. The .NET Framework is a MICROSOFT programming infrastructure for building, deploying, and running applications and services that use a Common Language Runtime (CLR) and a Framework Class Library. Information relating to the .NET Framework and VS is widely available, including at MICROSOFT's web site.

The facility thus enables developers to shorten the “write-debug-rewrite” cycle, quickly develop and test components and simple applications, and quickly analyze relationships between objects.

In various embodiments, developers can use the facility to create instances of objects, invoke methods the objects provide, inspect results, and perform other tasks. Object instances may appear in an OTB tool window as graphical shapes (e.g., rectangular icons). A developer can inspect objects using a “datatips” feature of the IDE by positioning a mouse pointer over the object. A developer can cause the IDE to invoke methods of the object, e.g., by right-clicking the object and selecting a command appearing in a menu.

In some embodiments, the IDE integrates the facility with a debugger to display data during debugging. As an example, when the OTB receives commands from the developer to interact with an instantiated object, such as to invoke a method or retrieve a property of the object, the OTB invokes methods of a code document object model (CodeDOM) API provided by the IDE to generate expressions. The CodeDOM API then provides the generated expressions to the debugger. The debugger executes or evaluates the expressions and provides results to the facility. The facility may display the results, such as in an OTB window. The OTB invokes an API of the debugger to command a design time expression evaluator (for consistency with the other acronym introductions DTEE) of the debugger. The DTEE evaluates expressions during design time by invoking portions of the executable object that is being debugged and returns the results, e.g., to the OTB. The OTB then displays the results to the developer. Thus, the OTB can enable a developer to test aspects of an object even when the IDE is in design time mode.

The OTB has a window that can display object instances that are currently “active” in a project that the IDE has loaded. The developer can instantiate active objects by creating instances of classes in the project or by requesting the OTB to invoke methods of an object that return other object instances. Class or object instances are represented by shapes in the OTB's tool window. Shapes have a context menu that enables the developer to inspect properties of its corresponding object, invoke the object's methods, and so forth. The OTB may also provide the developer with an option to invoke methods of classes in the .NET Framework.

The OTB provides several useful features to developers, including the following:
a) creating instances of a project class or other object using any of the public constructors of the class or object;
b) invoking public methods of objects and providing parameters to the methods;
c) causing the IDE or other components to fire events that the objects recognize;
d) inspecting and modifying members of objects, such as properties; and
e) taking other running or debugging actions relating to objects.

In some embodiments, the facility can record and replay actions a developer performs when using the OTB. This is similar to the “macro recording” functionality available in some MICROSOFT products to automate some tasks.

Illustrated Embodiment

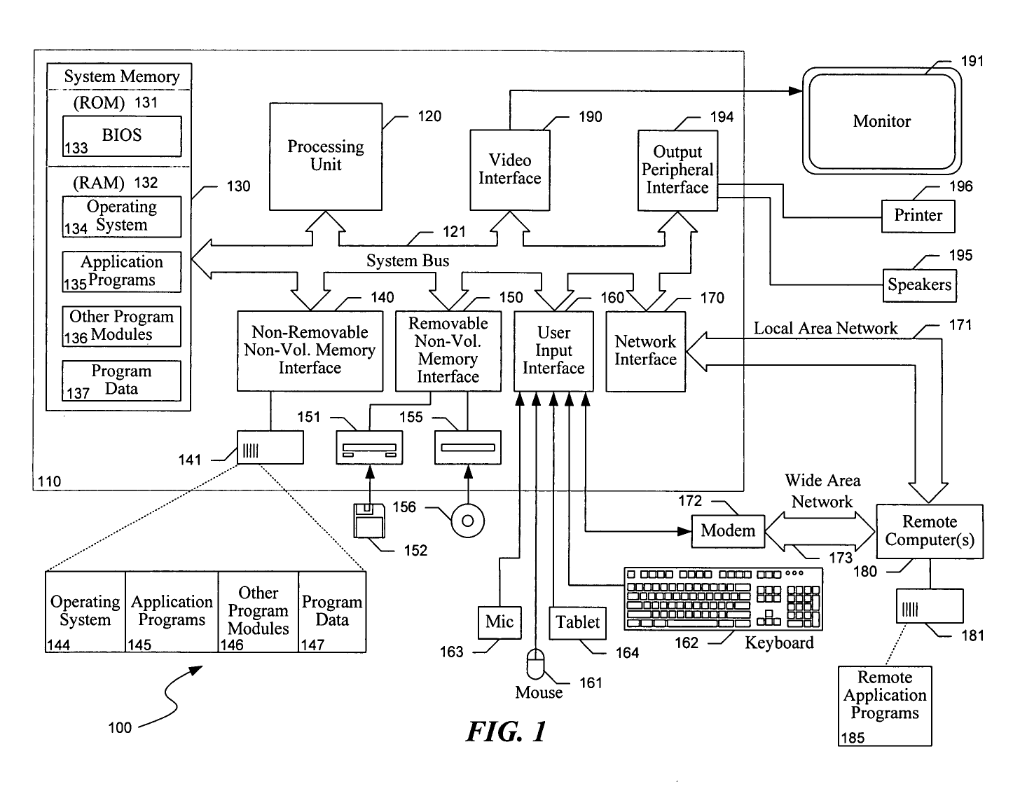

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the facility includes a general purpose computing device in the form of a computer 100. Components of the computer 100 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 100 typically includes a variety of computer-readable media. Computer-readable media can be any available media that can be accessed by the computer 100 and include both volatile and nonvolatile media and removable and nonremovable media. By way of example, and not limitation, computer-readable media may comprise computer storage media and communications media. Computer storage media include volatile and nonvolatile and removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 100. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 100, such as during start-up, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 100 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface, such as an interface 140, and the magnetic disk drive 151 and optical disk drive 155 are typically connected to the system bus 121 by a removable memory interface, such as an interface 150.

The drives and their associated computer storage media, discussed above and illustrated in FIG. 1, provide storage of computer-readable instructions, data structures, program modules, and other data for the computer 100. In FIG. 1, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers herein to illustrate that, at a minimum, they are different copies. A user may enter commands and information into the computer 100 through input devices such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch-screen panel can be physically coupled to a housing in which the computer 100 is incorporated, such as in a tablet-type personal computer. In addition, computing devices such as the computer 100 may also include other peripheral output devices such as speakers 195 and a printer 196, which may be connected through an output peripheral interface 194 or the like.

The computer 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 100, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 100 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 100 is connected to the LAN 171 through a network interface or adapter 170. When used in a WAN networking environment, the computer 100 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 100, or portions thereof, may be stored in the remote memory storage device 181. By way of example, and not limitation, FIG. 1 illustrates remote application programs 185 as residing on the memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Architecture

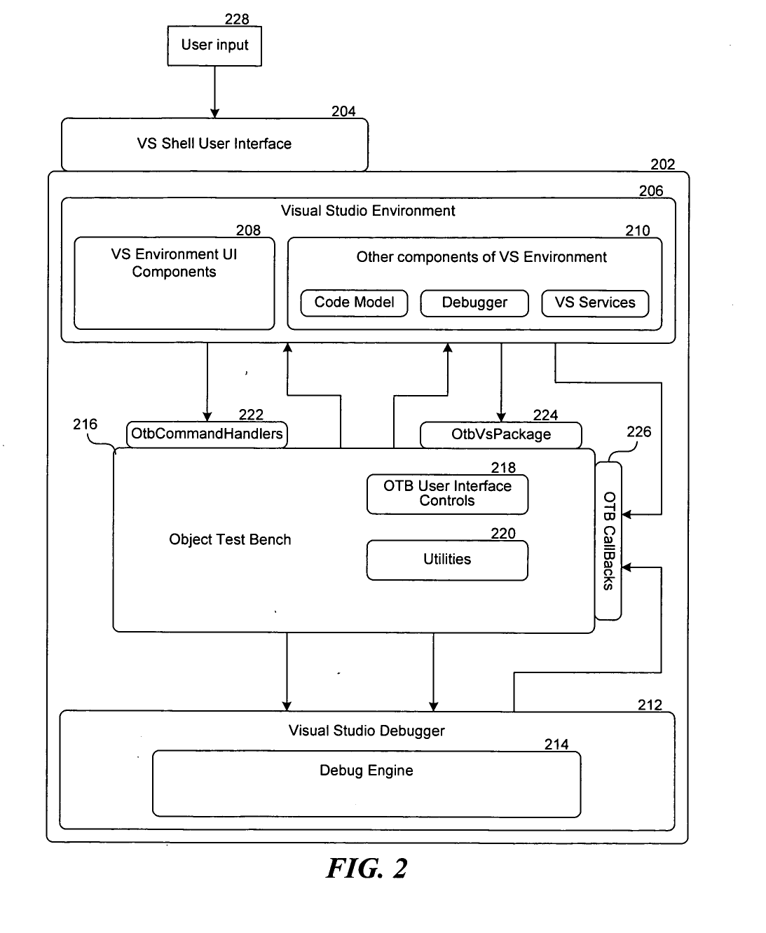

FIG. 2 is a block diagram illustrating components associated with the facility in various embodiments. An IDE 202 contains various components that, upon receiving user input 228 via a user interface 204, perform various development-related actions. These components include an environment 206 that provides a user interface (UI) via its UI component 208 and interacts with other components via its interaction components 210. The UI component provides UI windows, accepts commands, and so forth. The interaction components facilitate operation with a file system and provide various APIs for use by other components of the IDE. The IDE also includes a debugger component 212 that has a debug engine 214. The debug engine may contain multiple design time expression evaluators (DTEE) that are language-specific. As an example, the debug engine may have a DTEE for VISUAL C# and another for VISUAL BASIC.

The IDE is configured with an OTB 216 that contains various UI controls 218 and utilities 220. The UI controls enable the IDE to provide a UI and accept commands from a user. The utilities provide an API that facilitates interactions between the OTB and other components. The OTB also has a callback component 226 the use of which may provide callback functions or invoke callback functions that other components provide. The OTB may further provide command handlers 222 that receive and interpret commands from the IDE's UI components and package component 224. The package component handles the OTB's communications with the IDE's interaction components.

Various components may provide additional APIs that enable communication between the components. As an example, the OTB communicates with the debugger and debug engine by employing the debugger's APIs.

OTB Tool Window

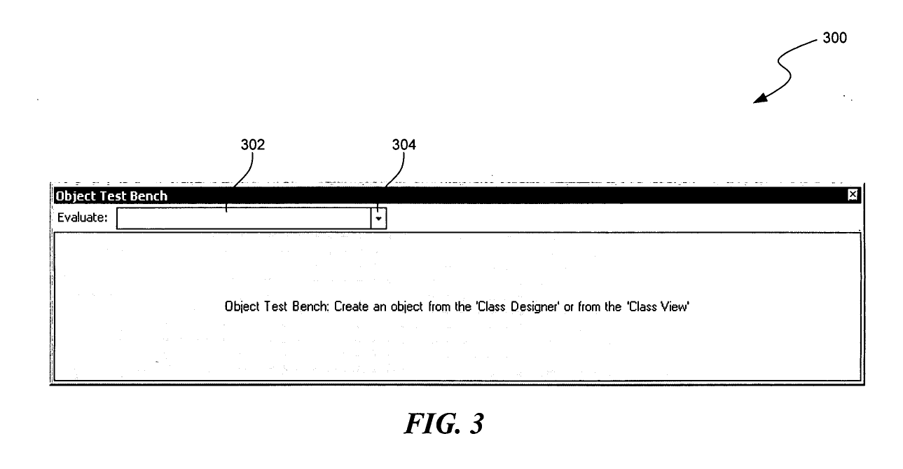

FIG. 3 is a display diagram illustrating an OTB tool window that the facility provides in various embodiments. The OTB tool window 300 is a dockable, resizable tool window that, by default, can be docked to an edge of the IDE, such as at the bottom edge. In some embodiments, an IDE may provide one instance of the OTB tool window and this tool window may be shared by all projects loaded by the IDE. In some embodiments, the OTB provides multiple tool windows. The OTB tool window opens when the developer selects one of various operations from a Class Designer or Class View of the IDE, such as “instantiate class.” It also opens by selection of a menu command, such as an Object Test Bench command appearing as a sub-menu item of a View menu. When there are no active objects, the OTB window may display a message, such as the “create an object” message illustrated in FIG. 3. In various embodiments, the OTB tool window may be active only during design time and may disappear when the environment switches to debug or runtime modes.

When objects are instantiated and appear in the OTB tool window, the OTB may display them in one of various “views,” such as upon request of the developer. These views include a tile view in which the facility displays objects left to right and then top to bottom; a list view; a details view; and a thumbnails view in which the facility provides visual indications of objects based on an object type.

The OTB tool window may have a combination box 302 in which the developer can type in an expression. A drop-down 304 may visually expand the combination box to display expressions previously input into the combination box.

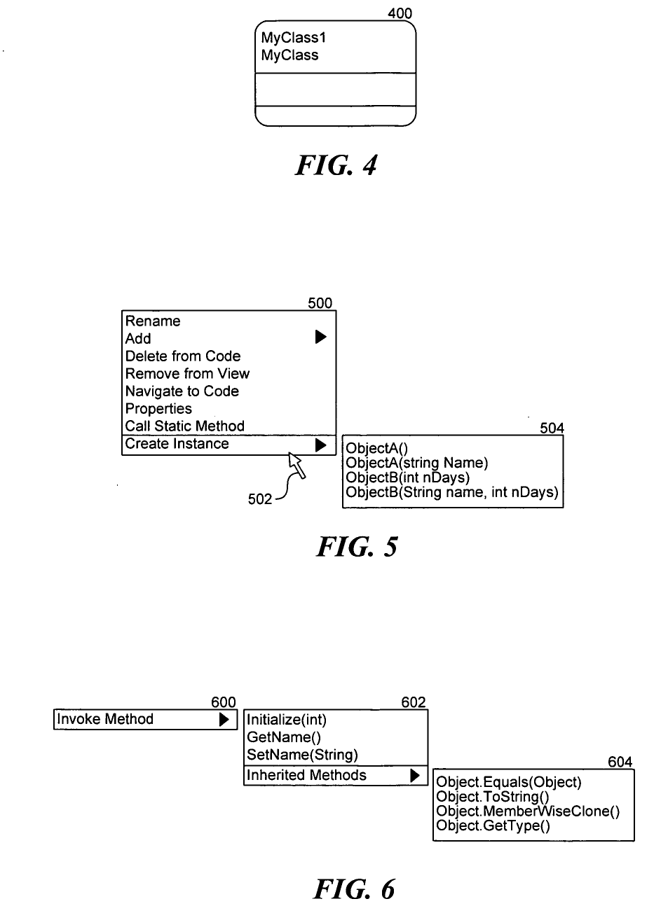

FIG. 4 is a display diagram illustrating an object appearing in an OTB tool window in various embodiments. The visual representation of the object 400 displays the object's instantiated name (here, “MyClass1”) and base type or base class (here, “MyClass”). When the names are too long, the facility may shorten the names and add ellipses. The facility may display full names when the developer positions a mouse pointer on the name, such as in a “datatip” window.

FIG. 5 is a display diagram illustrating a context menu 500 associated with the OTB tool window in various embodiments. When a developer positions a mouse pointer 502 in an OTB tool window, such as on a portion of the window's background or an object appearing in the OTB tool window 300 of FIG. 3, and then selects the context menu by either depressing a key on a keyboard or selecting a button on a mouse, the facility displays the context menu 500. The context menu has several options that may or may not be available depending on whether the developer has selected the window's background or an object in the window. As an example, a “create instance” option may be available when the user selects the window's background. Other illustrated examples include a rename, add, delete, remove, navigate, properties, and invoke (or “call”) method commands.

When the developer selects some of the commands available in the context menu, the facility may display additional menus. As an example, a menu 504 illustrates objects of which the OTB can create instances. In some embodiments, the facility determines from the IDE which objects the facility can add to the OTB. When the user selects an object from this additional menu, the facility creates an instance of the selected object. In some embodiments, when developers select an object to add, the facility may display an additional dialog box (not shown) to receive from the developer a name for the newly instantiated object.

In various embodiments, a developer can employ the facility to instantiate classes that are not defined to be abstract, enumerations, or primitive types.

FIG. 6 is a display diagram illustrating a context menu 600 associated with an “invoke method” command. The illustrated context menu 600 may appear when the developer selects an instantiated object and causes its context menu to appear. In some embodiments, the facility may provide additional commands in the context menu 600. When the developer selects the “invoke method” command, the facility displays methods associated with the selected object, such as in a menu 602 associated with the context menu. In some embodiments, the facility additionally displays methods associated with the object's ancestors, such as when the object inherits from other objects, as illustrated in block 604. In some embodiments, the facility may be unable to invoke some methods provided by the object. When this is the case, the facility may disable such methods in the menu 602. As an example, the facility in some embodiments may be unable to invoke methods that take a variable number of arguments. When this is the case, a method requiring multiple arguments may be grayed out in the menu 602.

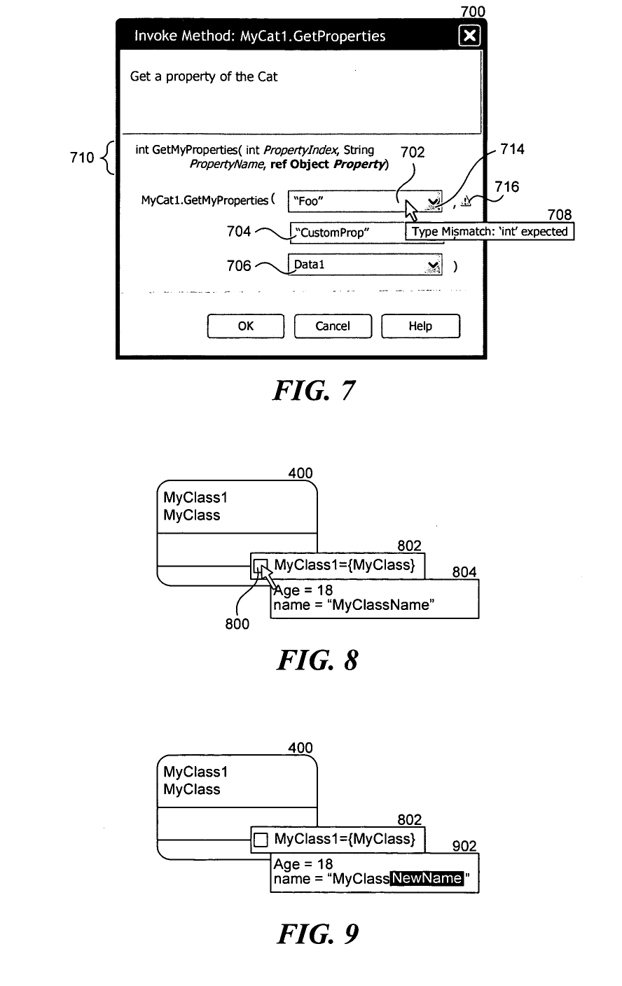

FIG. 7 is a display diagram illustrating a dialog box associated with the “invoke method” command. The facility displays a dialog box 700 when a developer selects an invoke method command from a context menu associated with an object. In various embodiments, the dialog box contains various text regions in which the developer can provide input to the method selected for invocation, such as arguments. As an example, the illustrated dialog box contains text regions 702, 704, and 706. These text regions may provide an ability for the developer to select input that the developer previously provided, such as by selecting a control 714 associated with the text region 702. These text regions correspond to parameters (e.g., arguments) expected by the selected method. When the developer provides input that does not correspond to the type of input expected by the method or makes other errors when providing input, the facility may provide a “real-time” indication of the error. As an example, an error region 708 appears when the developer provides input that does not match the type of input expected by the selected method. In some embodiments, the facility displays the error when the developer momentarily places the mouse pointer above a text region containing the error, such as after an error is indicated. An example of an indication of an error is an icon placed near a text region containing the error, such as an icon 716. The developer may be able to quickly determine what types of information the selected method expects by reviewing a template of the selected method, such as in a region 710.

FIG. 8 is a display diagram illustrating an object property inspection feature of the facility. In various embodiments, the facility enables the developer to inspect or view an instantiated object's properties. In the illustrated embodiment, a developer has requested the facility to display the object's properties by selecting an expand/collapse control 800 that appears adjacent to a property region 802. When the facility receives the request to display the object's properties in the property region, the facility may display the object's properties in an expanded property region 804. Thus, a developer can easily inspect properties associated with an instantiated object.

FIG. 9 is a display diagram illustrating an object property modification feature of the facility. In various embodiments, the facility enables the developer to modify an instantiated object's properties. In the illustrated embodiment, the developer has requested the facility to change the name property of the object. Whereas in region 804 of FIG. 8 the name property was “MyClassName,” the developer has changed it to “MyClassNewName” in region 902. Thus, a developer can easily modify properties associated with an instantiated object without writing or modifying source code.

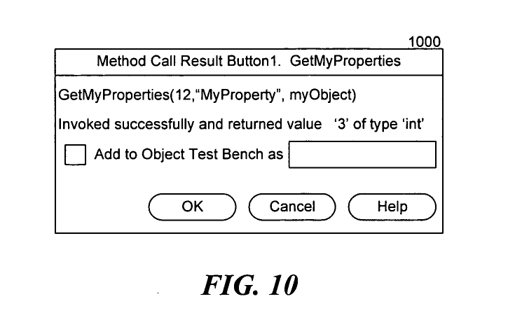

FIG. 10 is a display diagram illustrating a results window 1000 that the facility employs in various embodiments to return results to the developer. Once the developer provides parameters to the facility, such as by using the dialog box illustrated in FIG. 7, the facility provides results using this results window. In some embodiments, the facility employs the debug engine to generate results. If the invoked method is successful, the facility displays the results in the results window as is illustrated. If the return value is an object, the dialog box may additionally enable the developer to add the returned object to the OTB so that the new object can be manipulated by the developer by using the OTB.

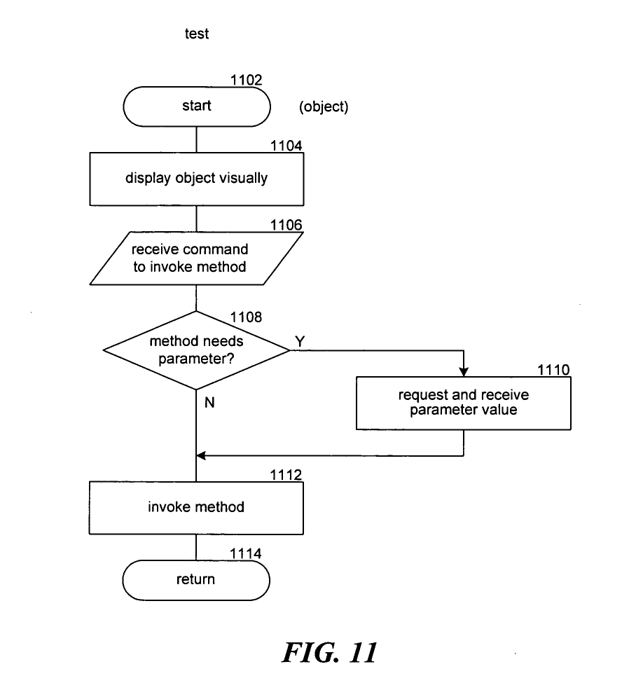

FIG. 11 is a flow diagram illustrating a test routine performed by the routine in various embodiments. The routine begins at block 1102 where it receives an indication of an object as a parameter.

At block 1104, the facility visually displays objects in an OTB tool window. As an example, the facility may display the objects in the OTB tool window after a developer has instantiated the objects.

At block 1106, the routine receives a command to invoke a method or function relating to the object. As an example, the facility may receive the command from the developer when the developer selects an “invoke method” command from a context menu relating to the indicated object.

At block 1108, the routine determines whether the method to be invoked requires parameters. If the method needs parameters, the routine continues at block 1110. Otherwise, the routine continues at block 1112.

At block 1110, the routine requests parameters from the user, such as by employing the dialog box illustrated in FIG. 7.

At block 1112, the routine invokes the indicated method and provides the parameters specified at block 1110, if any, to the invoked method. The facility may employ an API provided by the debugger to locate, begin, and stop execution of object code corresponding to the invoked method.

If the routine receives return values from the invoked method, the routine may display the return values, such as by employing the results window illustrated in FIG. 10.

At block 1114, the routine returns.

It will be appreciated by those skilled in the art that the above-described facility may be straightforwardly adapted or extended in various ways. For example, the facility can integrate into any IDE other than VS. While the foregoing description makes reference to particular embodiments, the scope of the invention is defined solely by the claims that follow and the elements recited therein.

I/We claim:

1. A method performed by a computer system for testing an object in an integrated development environment, comprising:
receiving an instance of an object;
displaying graphically the received instance of the object;
receiving a command to invoke a method of the instance of the object, the command indicating a method provided by the object without providing any source code;
determining whether the method requires a parameter; and
when the method requires a parameter,
requesting a value for the parameter;
receiving the value for the parameter; and
invoking the method and providing the received value for the parameter.

2. The method of claim 1 wherein the displaying graphically includes providing a user interface to enable a user to interact with the object.

3. The method of claim 1 including employing a debug engine of the integrated development environment to invoke the method.

4. The method of claim 1 including receiving a return value from the invoked method and providing an indication of the return value to a user.

5. The method of claim 4 wherein the return value is an object.

6. The method of claim 5 including instantiating the returned object so that the user can interact with the returned object.

7. A computer-readable medium having computer-executable instructions for performing a method of testing an object in an integrated development environment without providing source code or knowing semantics of a language, the method comprising:
receiving an instantiated object;
displaying a visual representation of the instantiated object;
receiving from a user a command relating to the instantiated object, the command received via a user interface of the integrated development environment, the integrated development environment operating in design mode; and
providing a result corresponding to the received command, the result associated with the instantiated object.

8. The computer-readable medium of claim 7 wherein the command is to invoke a function provided by the object.

9. The computer-readable medium of claim 8 wherein the function has a parameter and the receiving includes receiving a value for the parameter.

10. The computer-readable medium of claim 7 wherein the command is to inspect a property.

11. The computer-readable medium of claim 10 wherein the providing a result includes requesting a value of the property from the instantiated object and providing an indication of the value of the property to the user.

12. The computer-readable medium of claim 11 wherein the requesting includes communicating with a debug engine of the integrated development environment via an application program interface provided by the debug engine.

13. The computer-readable medium of claim 7 wherein the instantiated object is a class.

14. The computer-readable medium of claim 7 wherein the command is to modify a value of a property.

15. The computer-readable medium of claim 14 further comprising requesting a debug engine via an application program interface of the debug engine to modify the value of the property of the instantiated object wherein the integrated development environment is operating in design mode.

16. A system for testing an object in an integrated development environment without providing source code or knowing semantics of a language, comprising:
an integrated development environment having an environment, user interface, and an application program interface for interfacing with other components that register with the integrated development environment;
a debugger having a debug engine, application program interface, and at least one language-specific expression evaluation component; and
an object test bench that interfaces with the integrated development environment and debug engine to enable interactions with an object when the integrated development environment is operating in design time mode.

17. The system of claim 16 wherein the object test bench employs an application program interface of the debugger to cause the expression evaluation component to provide a result.

18. The system of claim 17 wherein the expression evaluation component is associated with a programming language compatible with .NET.

19. The system of claim 16 wherein the object test bench provides a graphical representation of the object on a tool window integrated with the integrated development environment but provided with the object test bench.

20. The system of claim 16 wherein a user interacts with the object via a context menu provided by the object test bench for the object, the context menu provided in an object test bench tool window.
